(19) United States
(12) Patent Application Publication
(10) Pub. No.: US 2024/0066743 A1
(43) Pub. Date: Feb. 29, 2024

(54) CHAINSAW CHAINS

(71) Applicant: MILWAUKEE ELECTRIC TOOL CORPORATION, Brookfield, WI (US)

(72) Inventors: Carter A. Gibson, Wauwatosa, WI (US); Peter R. Heath, Wauwatosa, WI (US); John J. Springer, Milwaukee, WI (US); Ian H.A. Blair, Wauwatosa, WI (US); Scott T. Moeller, Richfield, WI (US); James E. Pangerc, Pewaukee, WI (US)

(21) Appl. No.: 18/454,152

(22) Filed: Aug. 23, 2023

Related U.S. Application Data
(60) Provisional application No. 63/400,473, filed on Aug. 24, 2022.

(51) Int. Cl. B27B 33/14; B23D 65/00; B23K 11/08; B23K 26/24; B24B 3/36

(52) U.S. Cl. CPC B27B 33/144; B23D 65/00; B23K 11/08; B23K 26/24; B24B 3/36

(57) ABSTRACT

A chainsaw chain includes a plurality of drive links, a plurality of cutters, and a plurality of rivets. Each drive link includes a drive link body, a rivet hole extending through the drive link body, and a tang configured to engage a drive element of a chainsaw. Each cutter includes a cutter body having a rivet hole extending therethrough, a cutting tooth coupled to an upper portion of the cutter body, a carbide cutting tip coupled to the cutting tooth, a feed limiter coupled to the upper portion of the cutter body and spaced from the cutting tooth, and a gullet defined between the cutting tooth and the feed limiter. The plurality of rivets is received within corresponding rivet holes of the plurality of drive links and the plurality of cutters, to couple the plurality of drive links and the plurality of cutters together.

### CROSS-REFERENCE TO RELATED APPLICATIONS

The present application claims priority to U.S. Provisional Patent Application No. 63/400,473, filed Aug. 24, 2022, the entire content of which is incorporated herein by reference.

### FIELD OF THE INVENTION

The present invention relates to chainsaw chains.

### BACKGROUND OF THE INVENTION

A chainsaw chain typically includes cutters, drive links, tie straps, and rivets. The components of the chainsaw chain may be coupled to each other in various patterns and rotatably driven along a guide bar of a chainsaw to perform cutting operations.

### SUMMARY OF THE INVENTION

The invention provides, in one aspect, a chainsaw chain for a chainsaw. The chainsaw chain includes a plurality of drive links configured to connect the chainsaw chain to the chainsaw. Each drive link includes a drive link body, a rivet hole extending through the drive link body, and a tang extending from the drive link body and configured to engage a drive element of the chainsaw. The chainsaw chain further includes a plurality of cutters configured to cut a workpiece during a cutting operation. Each cutter includes a cutter body having a rivet hole extending therethrough, a cutting tooth coupled to an upper portion of the cutter body, a carbide cutting tip coupled to the cutting tooth, a feed limiter coupled to the upper portion of the cutter body and spaced from the cutting tooth, and a gullet defined between the cutting tooth and the feed limiter. Moreover, the chainsaw chain includes a plurality of rivets received within corresponding rivet holes of the plurality of drive links and the plurality of cutters to couple the plurality of drive links and the plurality of cutters together.

The invention provides, in another aspect, a method of manufacturing a chainsaw chain for a chainsaw. The method includes providing a plurality of drive links. Each drive link includes a drive link body, a rivet hole extending through the drive link body, and a tang extending from the drive link body and configured to engage a drive element of the chainsaw. The method also includes providing a plurality of cutters. Each cutter includes a cutter body having a rivet hole extending therethrough. The method further includes forming a cutting tooth on each cutter. The cutting tooth is made of a first material. In addition, the method includes welding a cutting tip to the cutting tooth of each cutter. The cutting tip is made of a second material that is different than the first material. Moreover, the method includes inserting a rivet into the rivet hole of each drive link and the rivet hole of each cutter to couple the plurality of drive links and the plurality of cutters together.

The invention provides, in another aspect, a method of manufacturing a chainsaw chain for a chainsaw. The method includes providing a plurality of drive links. Each drive link includes a drive link body, a rivet hole extending through the drive link body, and a tang extending from the drive link body and configured to engage a drive element of the chainsaw. The method also includes providing a plurality of cutters. Each cutter includes a cutter body having a pair of rivet holes extending therethrough. The cutter body defines a longitudinal axis extending through the pair of rivet holes. Each cutter also includes a cutting tooth coupled to an upper portion of the cutter body, a feed limiter coupled to the upper portion of the cutter body and spaced from the cutting tooth, and a gullet defined between the cutting tooth and the feed limiter. Moreover, the method includes coupling a cutting insert to the cutting tooth of each cutter, grinding the cutting insert to a desired shape, and inserting a rivet into the rivet hole of each drive link and the rivet hole of each cutter to couple the plurality of drive links and the plurality of cutters together.

Other aspects of the invention will become apparent by consideration of the detailed description and accompanying drawings.

### BRIEF DESCRIPTION OF DRAWINGS

FIG. 1 is a perspective view of a chainsaw.

FIG. 2 is a perspective view of a chainsaw chain according to an embodiment of the present invention.

FIG. 3 is a perspective view of a cutter according to an embodiment of the present invention.

FIG. 4 is a perspective view of a drive link according to an embodiment of the present invention.

FIG. 5 is a perspective view of a tie strap according to an embodiment of the present invention.

FIG. 6 is a side view of the cutter of FIG. 3, the cutter having a cutting tip coupled to a cutting tooth of the cutter by resistance welding.

FIG. 7 is an enlarged side view of a portion of a cutter according to another embodiment of the present invention, the cutter having a cutting insert coupled to a cutting tooth of the cutter by laser welding.

FIG. 8 is a perspective view of a cutter according to another embodiment of the present invention, the cutter having a cutting tip coupled to a cutting tooth of the cutter by laser welding.

FIG. 9 is a side view of a plurality of cutters, each cutter having a cutting insert coupled to a cutting tooth of the cutter by laser welding.

FIG. 10 is a side view of a portion of a chainsaw chain according to another embodiment, the chainsaw chain including a drive link with a cutting insert laser welded to a top portion of the drive link.

FIG. 11 is a flowchart depicting a method of manufacturing the chainsaw chain of FIG. 2.

FIG. 12 is a perspective view of a cutter according to another embodiment of the present invention, the cutter having a cutting insert welded to a cutting tooth of the cutter in a first orientation.

FIG. 13 is a top view of the cutter of the FIG. 12.

FIG. 14 is a perspective view of a cutter according to another embodiment of the present invention, the cutter having a cutting insert welded to a cutting tooth of the cutter in a second orientation.

FIG. 15 is a top view of the cutter of FIG. 14.

FIG. 16 is a perspective view of a cutter according to another embodiment of the present invention, the cutter having a cutting insert welded to a cutting tooth of the cutter in a third orientation.

FIG. 17 is a top view of the cutter of FIG. 16.

FIG. 18 is a perspective view of a cutter according to another embodiment of the present invention, the cutter having a cutting insert welded to a cutting tooth of the cutter in a fourth orientation.

FIG. 19 is a top view of the cutter of FIG. 18.

FIG. 20 is a flowchart depicting another method of manufacturing the chainsaw chain of FIG. 2.

FIG. 21 is a perspective view of a cutter according to another embodiment of the present invention, the cutter having a cutting tooth set in a left direction.

FIG. 22 is a front view of the cutter of FIG. 21.

FIG. 23 is another perspective view of the cutter of FIG. 21.

FIG. 24 is a perspective view of a cutter according to another embodiment of the present invention, the cutter having a cutting tooth set in a right direction.

FIG. 25 is a front view of the cutter of FIG. 24.

FIG. 26 is another perspective view of the cutter of FIG. 24.

FIG. 27 is a perspective view of a chainsaw chain including cutters set in a left direction and cutters set in a right direction.

FIG. 28 is a top, perspective view of the chainsaw chain of FIG. 27.

FIG. 29 is a front view of a cutter according to another embodiment of the present invention, the cutter having a cutting tip set at a first magnitude and in a left direction.

FIG. 30 is a front view of a cutter according to another embodiment of the present invention, the cutter having a cutting tip set at a second magnitude and in a left direction.

FIG. 31 is a front view of a cutter according to another embodiment of the present invention, the cutter having a cutting tip set at a first magnitude and in a right direction.

FIG. 32 is a front view of a cutter according to another embodiment of the present invention, the cutter having a cutting tip set at a second magnitude and in a right direction.

FIG. 33 is an enlarged view of a portion of the chainsaw chain of FIG. 2.

FIG. 34 is a top view of a portion of the chainsaw chain of FIG. 2.

FIG. 35 is a perspective view of a cutter according to another embodiment of the present invention, the cutter having a cutting insert with an axial orientation.

FIG. 36 is a top view of the cutter of FIG. 35.

FIG. 37 is a side view of the cutting insert of FIG. 35 having an axial orientation during a welding process.

FIG. 38 is a side view of the cutter of FIG. 35 outlined against a steel backer.

FIG. 39 is a perspective view of the cutting inserts of FIG. 35 welded to the steel backer of FIG. 38.

FIG. 40 is a perspective view of the steel backer of FIG. 38 with the cutting inserts ground to desired geometries.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

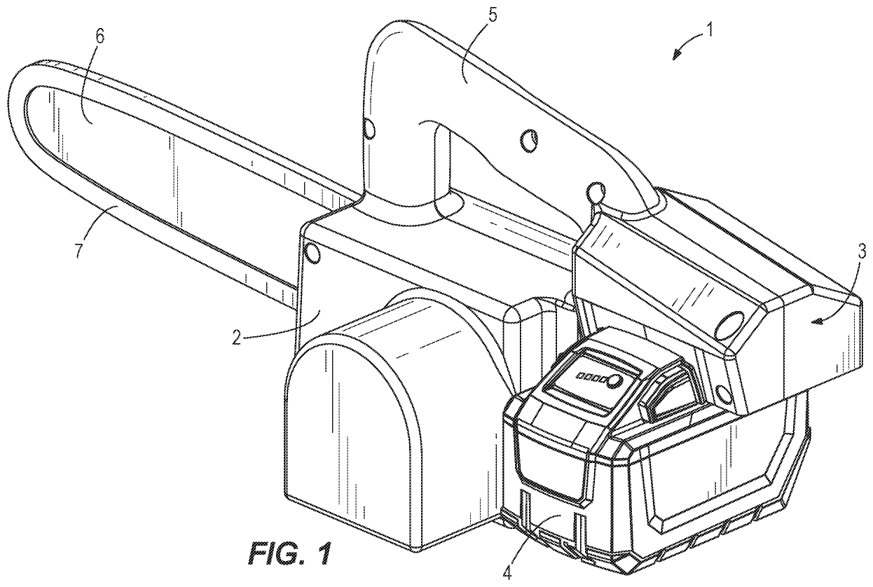

FIG. 1 illustrates a chainsaw 1 configured to perform cutting operations on a workpiece. The chainsaw 1 includes a housing 2 configured to support a motor and a drive mechanism, a battery receptacle 3 coupled to a rear portion of the housing 2, a power source 4 coupled to the battery receptacle 3, a handle 5 coupled to the housing 2 and the battery receptacle 3, a trigger coupled to the handle 5, and a guide bar 6 coupled to a front portion of the housing 2. In the illustrated embodiment, the power source 4 is a battery pack, such as an 18-volt Li-ion battery pack. The battery pack is configured to selectively supply power to the motor to activate the chainsaw 1. In other embodiments, the chainsaw 1 may have other types of power sources, such as a gasoline engine or an AC power cord. A chainsaw chain 7 is disposed along a periphery of the guide bar 6 and configured to be rotatably driven by the motor and the drive mechanism when the trigger is moved from an OFF position to an ON position. As the chainsaw chain 7 is driven along the guide bar 6, a user is able to perform cutting operations on material such as wood.

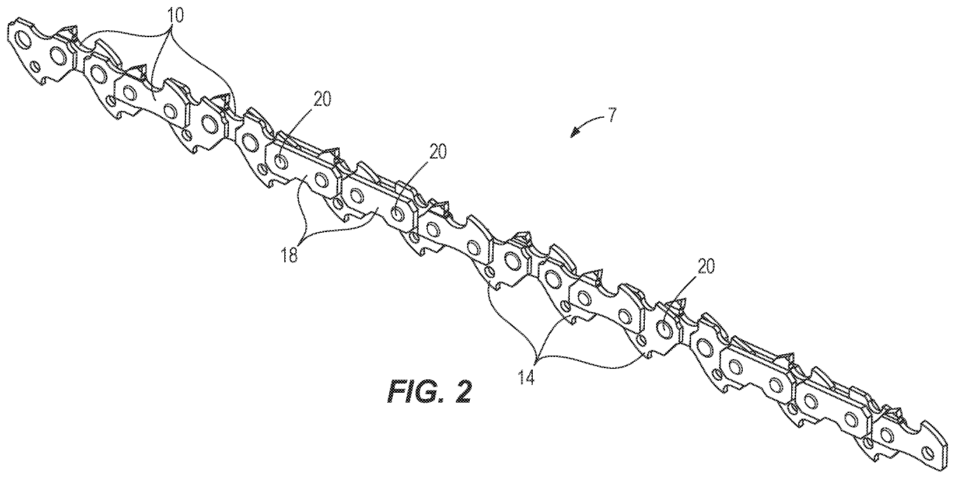

FIG. 2 illustrates an embodiment of the chainsaw chain 7. The illustrated chainsaw chain 7 includes a plurality of cutters 10, a plurality of drive links 14 positioned at a central portion of the chainsaw chain 7, and a plurality of tie straps 18 or tie links that interconnect consecutive drive links of the plurality of drive links 14. The cutters 10, the drive links 14 and the tie straps 18 are each coupled to each other by rivets 20. In some embodiments, the rivets 20 may undergo deformation to permanently couple the components of the chainsaw chain 7 together. In other embodiments, the cutters 10, the drive links 14 and the tie straps 18 may be coupled together by other suitable fasteners. Various cutting patterns of the chainsaw chain 7 are defined by the positioning of the cutters 10, the drive links 14, and the tie straps 18 and will be discussed herein below. Although different constructions and configurations of cutters, drive links, and tie straps are discussed separately below, the cutters, drive links, and tie straps may be used in any combination to form a chainsaw chain. Features of one cutter, drive link, or tie strap are equally applicable to another cutter, drive link, or tie strap.

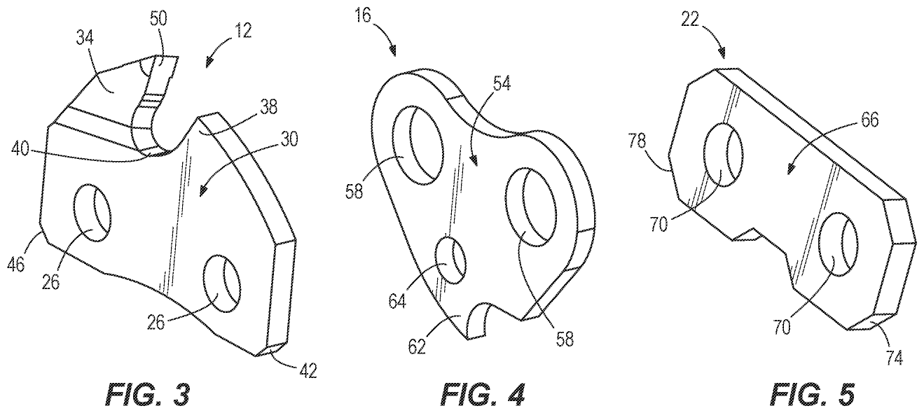

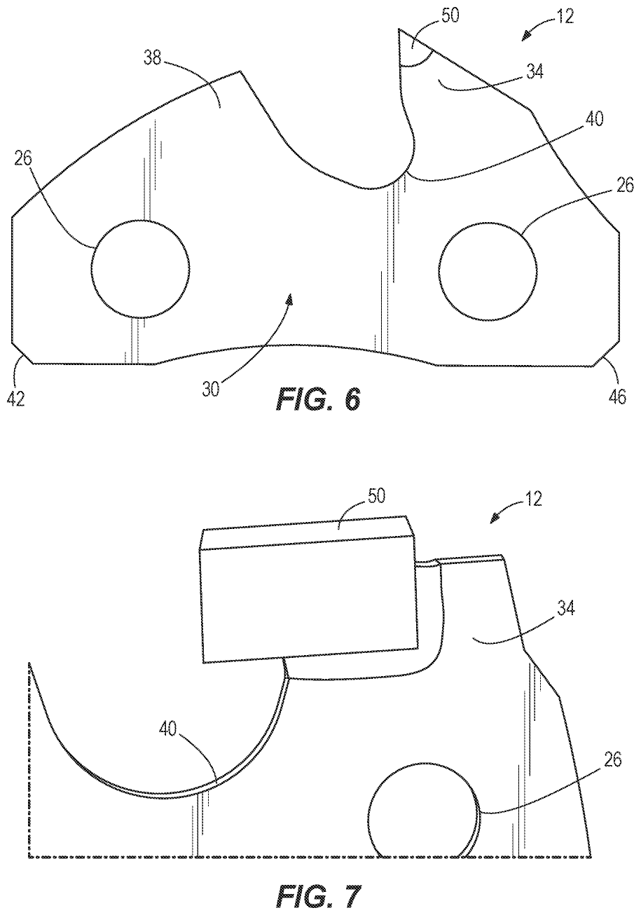

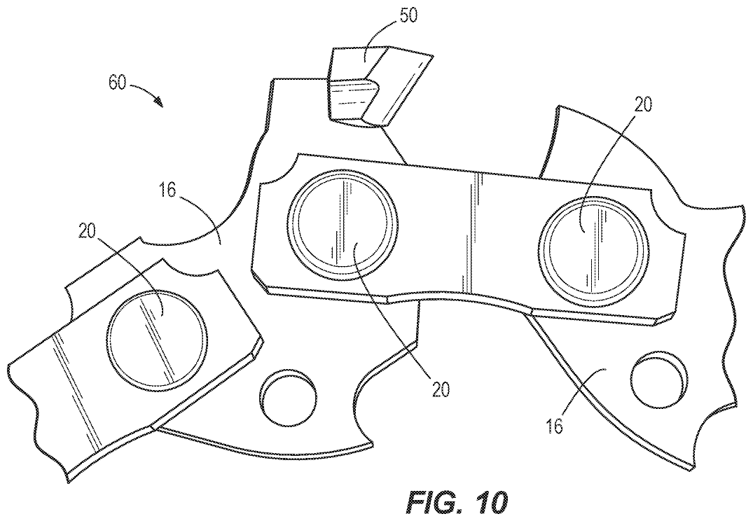

FIGS. 3 and 6 illustrate one cutter 12 of the plurality of cutters 10. The cutter 12 includes a cutter body 30, a cutting tooth 34, a feed limiter 38 or a depth gauge, a gullet 40, a toe 42, and a heel 46. The cutter body 30 includes one or more rivets holes 26 extending therethrough. Each rivet hole 26 is configured to receive a rivet 20 (FIGS. 2 and 10). The cutting tooth 34 is coupled to and extends from an upper portion of the cutter body 30. In the illustrated embodiment, the cutting tooth 34 is integrally formed with the cutter body 30. In other embodiments, the cutting tooth 34 may be a separate piece that is secured to the cutter body 30. The feed limiter 38 is also coupled to and extends from the upper portion of the cutter body 30. The feed limiter 38 is spaced apart from the cutting tooth 34 in front of the cutting tooth 34 in a cutting direction. In the illustrated embodiment, the feed limiter 38 is integrally formed with the cutter body 30. In other embodiments, the feed limiter 38 may be a separate piece that is secured to the cutter body 30. The feed limiter 38 is configured to limit how far the cutting tooth 34 can cut into a workpiece. The gullet 40 is defined between the cutting tooth 34 and the feed limiter 38. The toe 42 and the heel 46 are formed along a bottom portion of the cutter body 30. The toe 42 is positioned closer to the feed limiter 38, while the heel 46 is positioned closer to the cutting tooth 34. In the illustrated embodiment, each of the toe 42 and the heel 46 is formed as a chamfer-like edge.

The cutting tooth 34 of the cutter 12 is the portion of the chainsaw chain 7 that performs the cutting operation. The cutting tooth 34 includes a cutting tip 50 secured to a top portion of the cutting tooth 34. In some embodiments, the cutting tip 50 may be secured by various welding methods discussed below. After the cutting tip 50 is secured to the cutting tooth 34, the cutting tip 50 may then be ground to a desired shape. In some embodiments, the cutting tip 50 may be formed near-net shape prior to being secured to the cutting tooth 34. In such embodiments, the cutting tip 50 may be sharpened after it is secured to the cutting tooth 34. In the illustrated embodiment, the cutting tip 50 can take the size and shape of a cutting tooth from various types of saw blades (e.g., hole saw blade, circular saw blade, and reciprocating saw blade).

FIG. 4 illustrates one drive link 16 of the plurality of drive links 14. The drive link 16 includes a drive link body 54, one or more rivet holes 58 extending through the drive link body 54, and a tang 62 positioned below the pair of rivet holes 58. The rivet holes 58 are each configured to receive a rivet 20, so that the drive link 16 can be coupled to the cutter 12 and/or the tie strap 22. The tang 62 extends downwardly from the drive link body 54. In the illustrated embodiment, the tang 62 is integrally formed with the drive link body 54. In other embodiments, the tang 62 may be a separate piece that is secured to the drink link body 54. The tang 62 is defined by a curved gap formed within the drive link body 54 and is configured to support the chainsaw chain 7 along the guide bar 6 of the chainsaw 1. The tang 62 also engages a drive element moving within the guide bar 6 to drive the chainsaw chain 7 around the guide bar 6 and carry lubricating fluid (e.g., oil) through the guide bar 6 to keep the chainsaw chain 7 lubricated. The drive link 16 further includes an opening 64 proximate the tang 62. The opening 64 also carries and spreads lubricating fluid through the guide bar 6. Therefore, the chainsaw chain 7 can remain lubricated and attached to the guide bar 6 during operation of the chainsaw 1.

FIG. 5 illustrates one tie strap 22 of the plurality of tie straps 18. The tie strap 22 includes a tie strap body 66, one or more rivet holes 70 extending through the tie strap body 66, a toe 74, and a heel 78. The tie strap 22 is configured to interconnect the drive link 16 to the cutter 12 or consecutive drive links 14 to form the chainsaw chain 7. For example, one of the rivet holes 70 of the tie strap 22 may align with one of the rivet holes 58 of the drive link 16, while the other of the rivet holes 70 of the tie strap 22 may align with one of the rivet holes 26 of the cutter 12.

Referring back to FIG. 2, the chainsaw chain 7 is formed by coupling the plurality of cutters 10 to the plurality of drive links 14, and also coupling the plurality of drive links 14 to the plurality of tie straps 18. One of the rivet holes 26 of the cutter 12 is aligned and coaxial with one of the rivet holes 58 of the drive link 16, so that a rivet 20 can be received through the aligned rivet holes 26, 58 of the cutter 12 and the drive link 16. The rivet 20 may be deformed to permanently couple the cutter 12 to the drive link 16. The same process can also be used to permanently couple the tie strap 22 and the drive link 16 together.

To deform the rivet 20 such that the cutter 12, the drive link 16, and the tie strap 22 are coupled to each other, the rivet 20 can be forged. The rivet 20 includes a rivet head, a rivet end opposite the rivet head, and a rivet shaft disposed between the rivet head and the rivet end. Once the rivet 20 is received through corresponding rivet holes 26, 58, 70, either the cutter 12, the drive link 16, or the tie strap 22 is placed along the rivet shaft as the rivet head is positioned against a surface of either the cutter 12, the drive link 16, or the tie strap 22. The rivet end can then be deformed, such that the rivet end enlarges to a diameter about two times larger than a diameter of the rivet shaft. After the rivet end has been deformed, the cutter 12, the drive link 16, and the tie strap 22 are then enclosed between the rivet head and the rivet end and permanently coupled to each other.

In reference to FIGS. 3 and 6, the cutting tip 50 is coupled to the cutting tooth 34 by resistance welding. To couple the cutting tip 50 to the cutting tooth 34, pressure is first applied along the areas of the cutting tip 50 and the cutting tooth 34 that are to be welded together. As pressure is applied, a current can then be passed through the cutting tip 50 and the cutting tooth 34 to form a weld. To perform resistance welding, the material(s) used should conduct electricity. In some embodiments, the cutting tip 50 can be formed of carbide, while the cutting tooth 34 can be formed of steel, such as high speed steel. In other embodiments, the cutting tip 50 and/or the cutting tooth 34 can be formed of other materials.

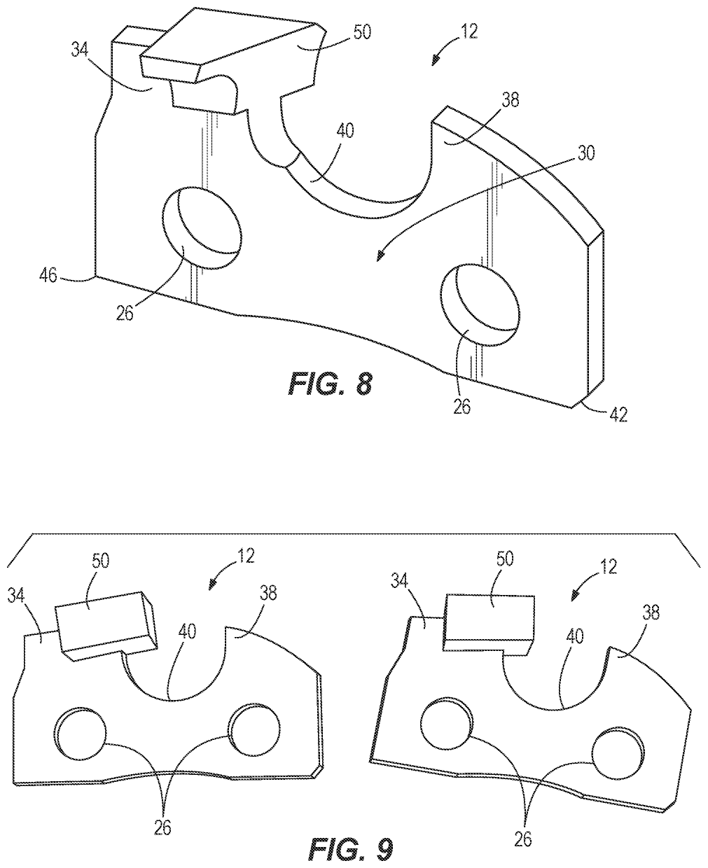

In reference to FIGS. 7-9, the cutting tip 50 is coupled to the cutting tooth 34 by laser welding. In this process, a laser is used to create narrow and deep welds by concentrating heat along contacting surfaces of the cutting tooth 34 and the cutting tip 50. Laser welding can provide a decrease in production time of the cutter 12 in comparison to conventional welding methods. In some embodiments, the cutting tip 50 can be formed of carbide, while the cutting tooth 34 can be formed of steel, such as high speed steel. In other embodiments, the cutting tip 50 and/or the cutting tooth 34 can be formed of other materials. In the embodiment shown in FIGS. 7 and 9, the cutting tips 50 are unshaped blocks of material. After the cutting tip 50 is laser welded to the cutting tooth 34, the cutting tip 50 is then ground to a desired shape, as illustrated in FIG. 8.

In reference to FIG. 10, a cutting tip 50 can also be coupled to a top portion of the drive link 16 of FIG. 4. Similar to the cutting tooth 34 shown in FIGS. 3 and 6, the cutting tip 50 can be resistance welded to the drive link. Alternatively, similar to the cutting tooth 34 shown in FIGS. 7-9, the cutting tip 50 can be laser welded to the drive link 16. After being secured to the drive link 16, the cutting tip 50 can also be ground to a desired shape. Alternatively, the cutting tip 50 can be secured to the drink link 16 in a near-net shape and sharpened. With the cutting tip 50, the drive link 16 can simultaneously perform cutting operations and hold the chainsaw chain 7 along the guide bar 6 of the chainsaw 1 during operation.

As noted above, the cutting tip 50 of the cutting tooth 34 (or the drive link 16) can be made of carbide. Using carbide provides the chainsaw chain 7 with a longer cutting life compared to conventional steel cutting teeth. In other embodiments, the cutting tip 50 can be made of other materials, such as diamond or cermet.

As illustrated, the cutting tip 50 may have a generally polygonal (e.g., rectangular) shape. The polygonal shape allows the cutting tip 50 to be wide enough to cover the cross-section of the guide bar 6 of the chainsaw 1. The cutting tip 50, however, is not limited to a polygonal shape. For example, the cutting tip 50 can alternatively be cylindrical, spherical, etc. Having the cutting tip 50 take the form of different shapes allows the cutting tip 50 to be placed at different positions along the cutting tooth 34. Moreover, the different shapes of the cutting tip 50 allows the cutting tooth 34 to form either a thin or wide shape.

In another embodiment, the cutting tip 50 can be coupled to (e.g., formed on) the cutting tooth 34 by cladding. During the cladding procedure, a system is configured to supply a granular or powder material along the outer surface of the cutting tooth 34. An energy source, within the system, applies heat to the powder material and a target area of the cutting tooth 34. The energy source also provides a laser beam configured to be positioned on the target area of the cutting tooth 34. The heat applied by the energy source melts the powder material and the target area of the cutting tooth 34, such that the powder material and the cutting tooth 34 fuse together as the laser beam passes along the target area of the cutting tooth 34. As a result, the cutting tooth 34 and the powder material forms a bonded coating layer. The cutting tooth 34 is arranged to be movable relative to the system, so that during the cladding operation, the cutting tip 50 can be laser cladded to the cutting tooth 34 once the powder material is fused with the cutting tooth 34. In this case, the cutting tip 50 can be made of carbide and high-speed steel. In some embodiments, the entire cutting tooth 34, or even the entire cutter 12, can be formed by cladding, rather than only the cutting tip 50.

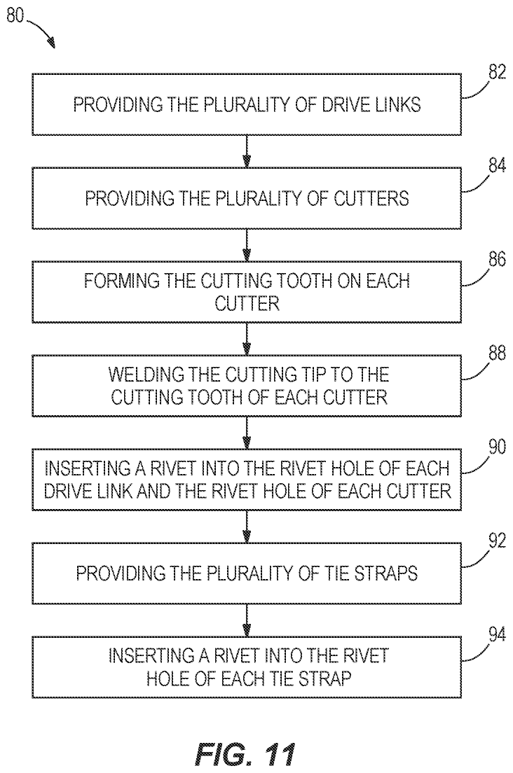

FIG. 11 depicts a method 80 for manufacturing the chainsaw chain 7 of FIG. 2. At step 82, the plurality of drive links 14 is provided. The plurality of drive links 14 is configured to engage the drive element of the chainsaw 1 to connect the chainsaw chain 7 to the chainsaw 1. Each drive link 14 may take the form of, for example, the drive link 16 of FIG. 4. At step 84, the plurality of cutters 10 is provided for cutting a workpiece during a cutting operation. Each cutter 10 may take the form of, for example, the cutter 12 of FIGS. 3 and 6-9. In other embodiments, each cutter 10 may take the form of other cutters discussed herein below. At step 86, the cutting tooth 34 is formed on each cutter 10. The cutting tooth 34 is a made of a first material, such as steel. In other embodiments, the first material can be other suitable materials.

At step 88, the cutting tip 50 is welded to the cutting tooth 34 of each cutter 10. As noted above, the cutting tip 50 may be made of a second material. In some embodiments, the second material is carbide. In other embodiments, the second material can be other materials such as, diamond or cermet. The cutting tip 50 is welded to the cutting tooth 34 by various welding methods such as, but not limited to, resistance welding, laser welding, and cladding. At step 90, a rivet 20 is inserted into the rivet hole 58 of each drive link 16 and the rivet hole 26 of each cutter 10 to couple the plurality of drive links 14 and the plurality of cutters 10 together. At step 92, the plurality of tie straps 18 is provided. Each tie strap 18 may take the form of the tie strap 22 of FIG. 5. At step 94, a rivet is inserted into the rivet hole 70 of each tie strap 18 to couple the plurality of drive links 16, the plurality of cutters 10, and the plurality of tie straps 18 together. In some embodiments, the step 90 and the step 94 may be combined into a single step.

In some embodiments, the method 80 may not include all of the steps described above or may include additional steps before, after, or between the depicted steps. In addition, the steps may be performed in other orders.

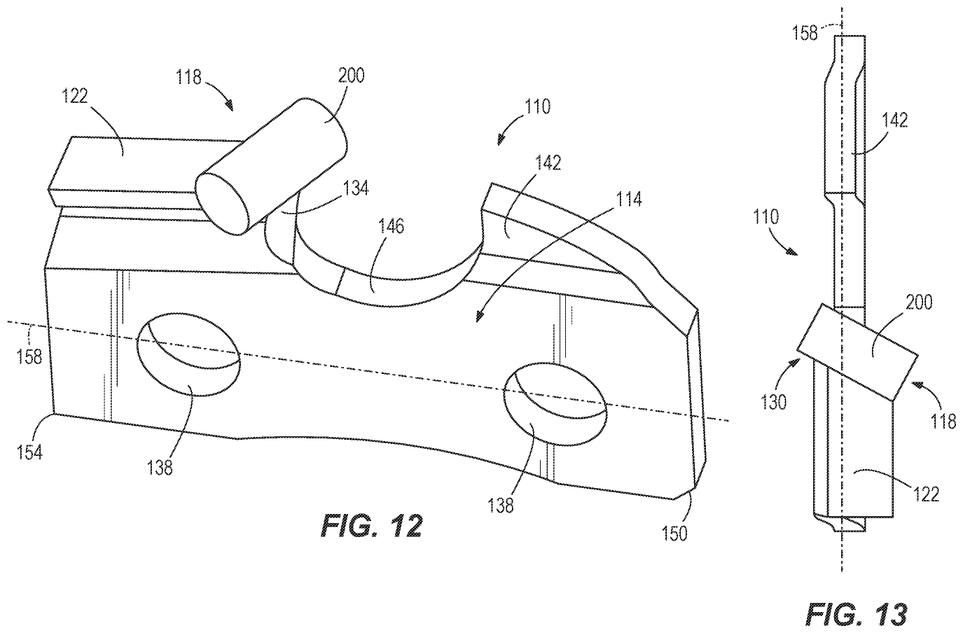

FIGS. 12 and 13 illustrate another embodiment of a cutter 110. The cutter 110 includes a cutter body 114 and a cutting tooth 118. The illustrated cutting tooth 118 has a top plate 122 that extends outward and perpendicular to the cutter body 114, a lead edge 130 defining a cutting corner, and a side plate 134. Specifically, the lead edge 130 and the side plate 134 are defined along a side of the top plate 122. The cutter 110 further includes one or more rivet holes 138 extending through the cutter body 114, a feed limiter 142, a gullet 146 positioned between the feed limiter 142 and the cutting tooth 118, a toe 150, and a heel 154. The lead edge 130 and the side plate 134 are proximate the gullet 146. The cutter body 114 also defines a longitudinal axis 158 of the cutter 110 extending through the rivet holes 138. The top plate 122 of the cutting tooth 118 is also oriented at a relief angle relative to the longitudinal axis 158 of the cutter 110.

The illustrated cutter 110 also includes a cutting insert 200 coupled to a portion of the top plate 122. The cutting insert 200 may be, for example, a piece of carbide. In the illustrated embodiment, the cutting insert 200 is shown as a cylindrical piece, but may alternatively have other shapes. Once the cutting insert 200 is attached to the cutting tooth 118, the cutting insert 200 is then ground to a desired shape. The desired shape of the cutting insert 200 can be based on the positioning of the cutting insert 200 and a specific operation task.

With continued to reference to FIGS. 12 and 13, the cutting insert 200 is welded (e.g., resistance welded, laser welded, etc.) along a surface of the lead edge 130. Specifically, the cutting insert 200 is parallel to the lead edge 130 and oriented at an oblique angle relative to the longitudinal axis 158 of the cutter 110. For example, the cutting insert 200 may be angled between 45 degrees and 75 degrees relative to the longitudinal axis 158. Similar to the top plate 122 of the cutter 110, the cutting insert 200 is also oriented perpendicular to the cutter body 114. In this orientation, the cutting insert 200 can fully support the cutting tooth 118 during operation.

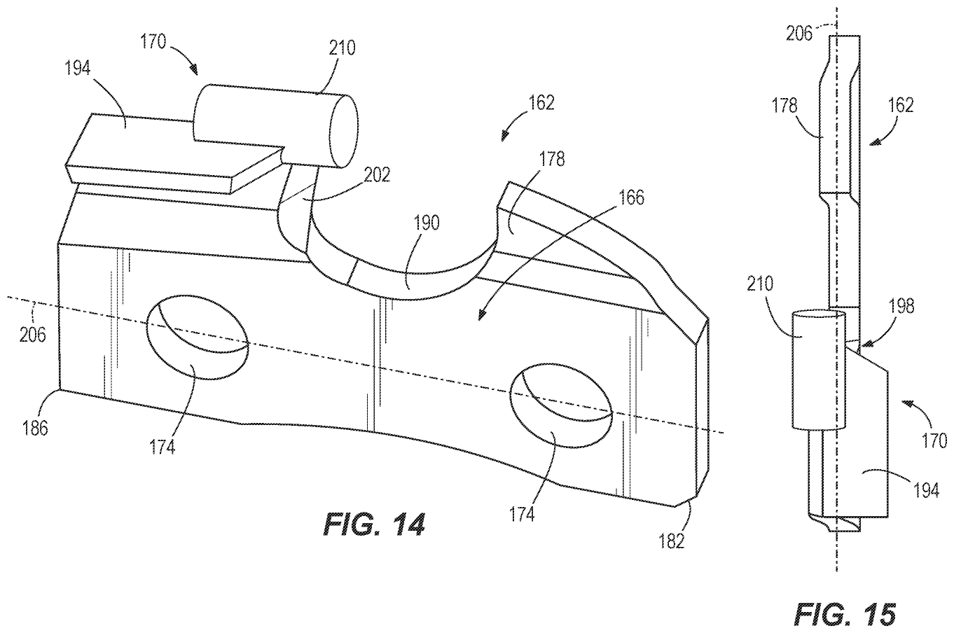

FIGS. 14 and 15 illustrate another embodiment of a cutter 162. The cutter 162 includes a cutter body 166, a cutting tooth 170, one or more rivet holes 174 extending through the cutter body 166, a feed limiter 178, a toe 182, and a heel 186. The cutting tooth 170 and the feed limiter 178 are integrally formed along the cutter body 166, such that a gullet 190 is defined therebetween. The cutting tooth 170 includes a top plate 194, a lead edge 198, and a side plate 202. The lead edge 198 and the side plate 202 of the cutting tooth are defined along a side of the top plate 194 proximate the gullet 190. The cutter body 166 defines a longitudinal axis 206 extending through the rivet holes 174.

The illustrated cutter 162 also includes a cutting insert 210 coupled to (e.g., welded to) a surface of the top plate 194. In the illustrated embodiment, the cutting insert 210 extends in a direction parallel to the longitudinal axis 206 of the cutter 162. The cutting insert 210 overlaps a portion of the gullet 190, thereby extending a portion of the cutting corner of the lead edge 198. Therefore, the cutting tooth 170 is partially supported as the cutting insert 210 is only attached to a portion of the lead edge 198.

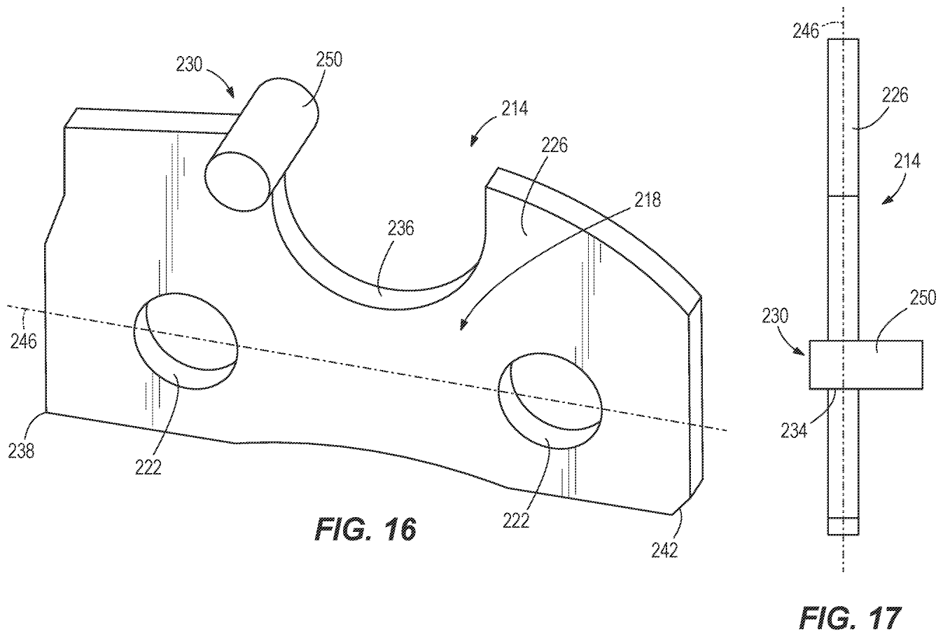

FIGS. 16 and 17 illustrate another embodiment of a cutter 214. In the illustrated embodiment, the cutter 214 is a flat cutter that does not include a top plate. The cutter 214 includes a cutter body 218 having one or more rivet holes 222 extending therethrough, a feed limiter 226, a cutting tooth 230 having a lead edge 234, a gullet 236 defined between the cutting tooth 230 and the feed limiter 226, a heel 238, and a toe 242. The cutter body 218 defines a longitudinal axis 246 extending through the rivet holes 222.

The illustrated cutter 214 also includes cutting insert 250 coupled to (e.g., welded to) the lead edge 234 of the cutting tooth 230. At least a portion of the cutting insert 250 overlaps the gullet 236, as the cutting insert 250 extends transverse to the longitudinal axis 246 of the cutter 214. In particular, the cutting insert 250 extends perpendicular to the longitudinal axis 246. The cutting insert 250 covers the cross section of the cutter 214, as well as the guide bar 6 of the chainsaw 1, to provide a wide cutting tooth 230. As the cutting insert 250 extends along the lead edge 234 of the cutting tooth 230, the cutting insert 250 can fully support the cutting tooth 230 during operation.

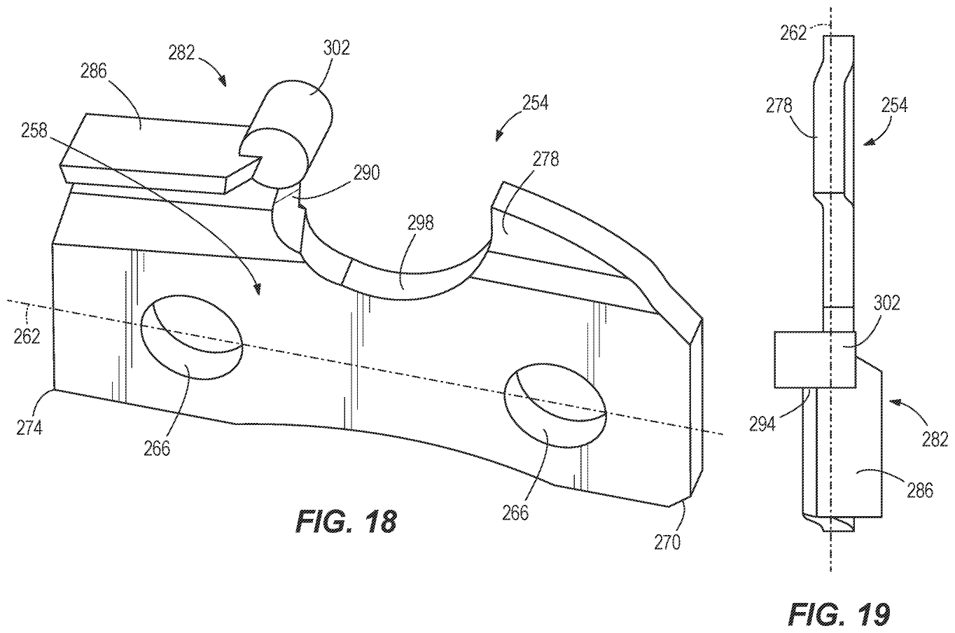

FIGS. 18 and 19 illustrate another embodiment of a cutter 254. The cutter 254 includes a cutter body 258 that defines a longitudinal axis 262 of the cutter 254, one or more rivet holes 266 extending through the cutter body 258, a toe 270, a heel 274, and a feed limiter 278. The cutter 254 further includes a cutting tooth 282 having a top plate 286, a side plate 290, and a lead edge 294. A gullet 298 is also disposed between the cutting tooth 282 and the feed limiter 278. The side plate 290 and the lead edge 294 of the cutting tooth 282 are defined along a side of the top plate 286 proximate the gullet 298. The longitudinal axis 262 extends through the rivet holes 266.

The illustrated cutter 254 also includes a cutting insert 302 coupled to (e.g., welded to) a portion of the lead edge 294 of the cutting tooth 282, such that the cutting insert 302 is oriented transverse to the longitudinal axis 262 of the cutter 254. In particular, the cutting insert 302 extends perpendicular to the longitudinal axis 262. The cutting insert 302 is positioned to cover a cutting corner of the lead edge 294, thereby expanding the cutting corner of the lead edge 294 in a direction transverse the longitudinal axis 262 of the cutter 254. A portion of the cutting insert 302 overlaps a portion of the gullet 298. In this embodiment, the cutting insert 302 is positioned to partially support the cutting tooth 282.

In reference to FIGS. 12-19, each cutting insert 200, 210, 250, 302 preferably takes the form of a cylinder. However, each cutting insert 200, 210, 250, 302 is not limited to a cylindrical shape; rather, each cutting insert 200, 210, 250, 302 can be rectangular, spherical, etc. Each cutting insert 200, 210, 250, 302 is also made of carbide, although materials of similar properties can be attached to the respective cutters 110, 162, 214, 254.

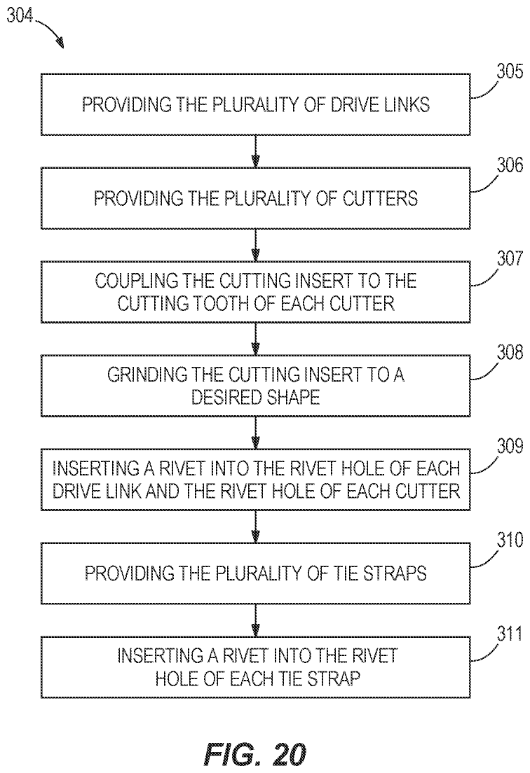

FIG. 20 depicts a method 304 of manufacturing the chainsaw chain 7 of FIG. 2. At step 305, the plurality of drive links 14 is provided. The plurality of drive links 14 is configured to engage the drive element of the chainsaw 1 to connect the chainsaw chain 7 to the chainsaw 1. Each drive link 14 may take the form of, for example, the drive link 16 of FIG. 4. At step 306, the plurality of cutters 10 is provided to cut a workpiece during a cutting operation. Each cutter 10 may take the form of, for example, the cutters 110, 162, 214, 254 of FIGS. 12-19. In other embodiments, each cutter 10 may take the form of other cutters discussed herein. At step 307, the cutting inserts 200, 210, 250, 302 are coupled to the cutting tooth 118, 170, 230, 282 of each cutter 110, 162, 214, 254 in a specific orientation. At step 308, the cutting inserts 200, 210, 250, 302 are ground to a desired shape. At step 309, a rivet is inserted into the rivet hole 58 of each drive link 16 and the rivet hole 26 of each cutter 10 to couple the plurality of drive links 14 and the plurality of cutters 10 together. At step 310, the plurality of tie straps 18 is provided. Each tie strap 18 may take the form of, for example, the tie strap 22 of FIG. 5. At step 311, another rivet is inserted into the rivet hole 70 of each tie strap 18 to couple the plurality of drive links 16, the plurality of cutters 10, and the plurality of tie straps 18 together. In some embodiments, the step 309 and the step 311 may be combined into a single step.

In some embodiments, the method 304 may not include all of the steps described above or may include additional steps before, after, or between the depicted steps. In addition, the steps may be performed in other orders.

In another embodiment of the cutter 110, the cutting insert 200 is ground to an initial desired shape before being welded to the cutting tooth 118. After the cutting insert 200 is welded to the cutting tooth 118, the cutting insert 200 is then ground or sharpened to a final desired shape. Grinding the cutting insert 200 before the welding process forms the initial desired shape into a shape that is similar to the final desired shape. The production of the cutter 110 becomes an easier process, since the time it takes to grind the cutting insert 200 when welded to the cutting tooth 118 is reduced. Additionally, the process of grinding the cutting insert 200 may be easier since the features of the cutter 110 will not interfere during the process.

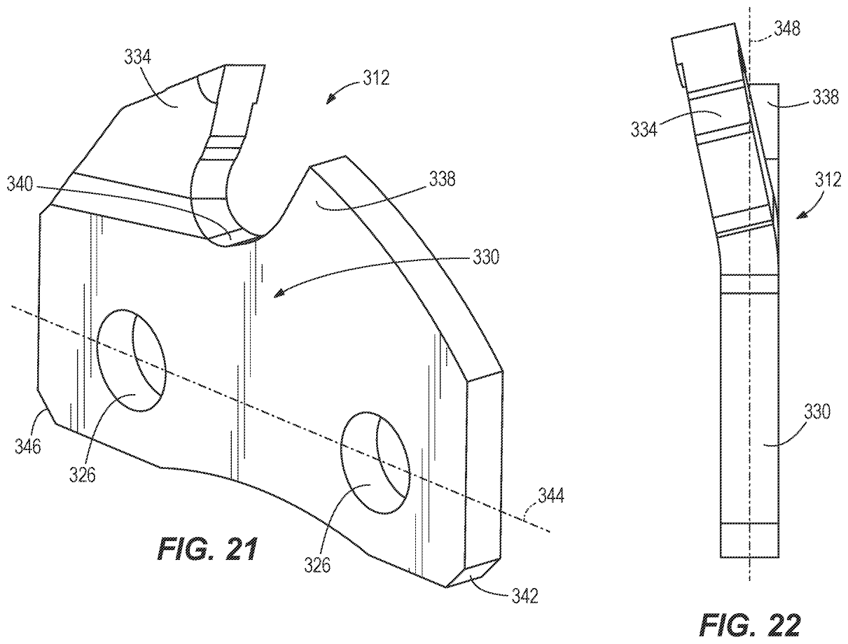

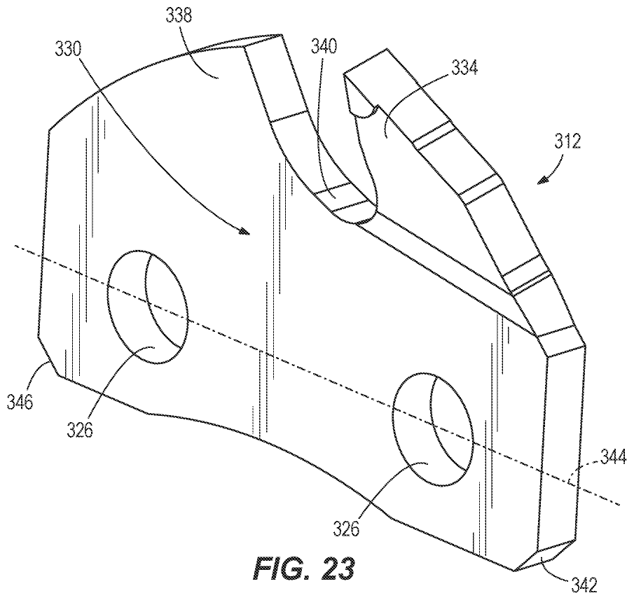

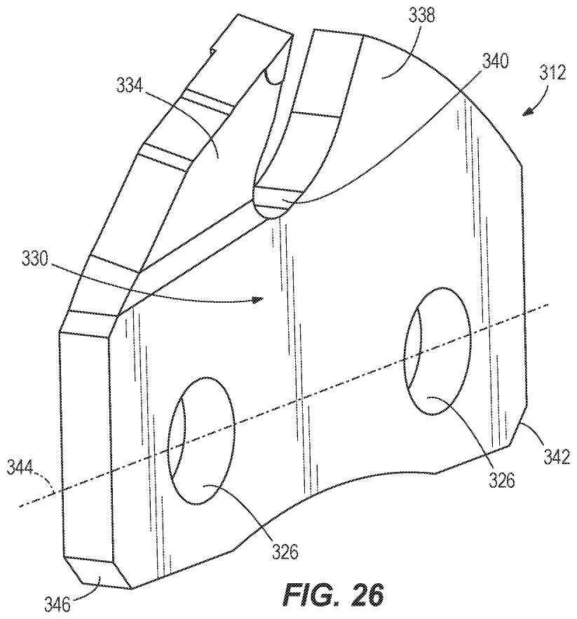

FIGS. 21-26 illustrate other embodiments of a cutter 312. The cutter 312 is similar to the cutter 12 of FIG. 3; therefore, like structure will be identified by like reference number plus “300.”

In the embodiments of FIGS. 21-26, the cutter 312 includes a cutter body 330 having one or more rivet holes 326 extending therethrough, a cutting tooth 334, a feed limiter 338, a gullet 340 positioned between the feed limiter 338 and the cutting tooth 334, a toe 342, and a heel 346. The cutting tooth 334 is oriented at an oblique angle relative to the cutter body 330. That is, the cutting tooth 334 is set (i.e., bent) in either a right direction or a left direction of the cutter 312. As the cutting tooth 334 extends in either the left direction or the right direction, the cutting tooth 334 is then configured to extend non-parallel to the feed limiter 338 of the cutter 312. The cutter 312 also defines a longitudinal axis 344 extending through the rivet holes 326 and a vertical axis 348 oriented perpendicular to the longitudinal axis 344.

In reference to FIGS. 21-23, the cutting tooth 334 is set in the left direction and non-parallel to the vertical axis 348 defined by the cutter 312. For example, the cutting tooth 334 may be set between 5 degrees and 15 degrees relative to the vertical axis 348. Therefore, the cutting tooth 334 is oriented at an oblique angle relative to the cutter body 330. As the cutting tooth 334 is configured to extend non-parallel to the vertical axis 348, the cutting tooth 334 is structured to overlap a portion of the guide bar 6 of the chainsaw 1 from the left direction.

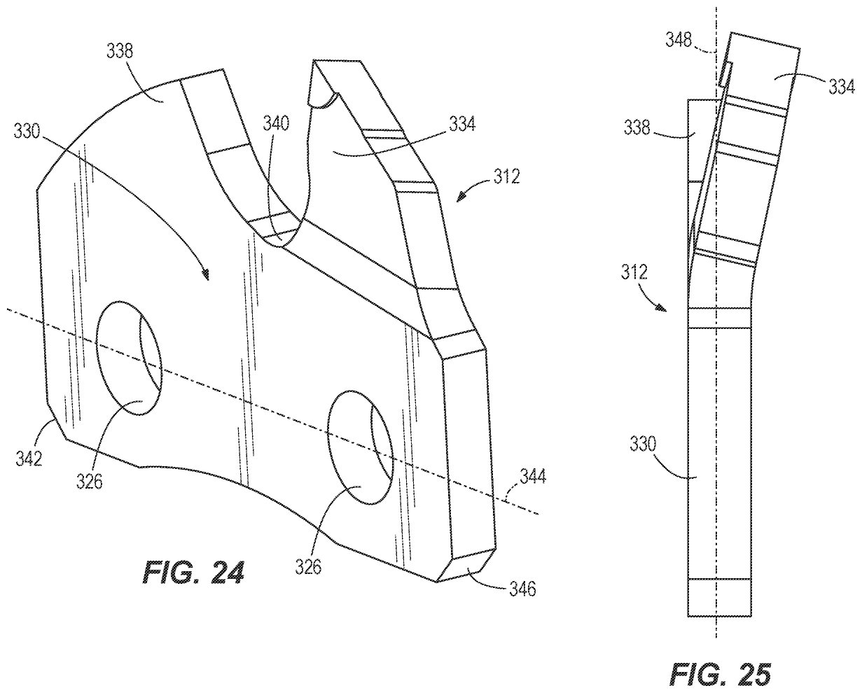

The cutting tooth 334 of the cutter 312 illustrated in FIGS. 24-26 is set in the right direction and non-parallel to the vertical axis 348 of the cutter 312. For example, the cutting tooth 334 may be set between 5 degrees and 15 degrees relative to the vertical axis 348. The cutting tooth 334 is thereby oriented at another oblique angle of relative to the cutter body 330 of the cutter 312. Having cutters 312 with cutting teeth 334 that extend in either the right direction or the left direction, allows the chainsaw chain 7 to make even cuts along a workpiece as the chainsaw chain 7 cuts the material from the left direction and the right direction.

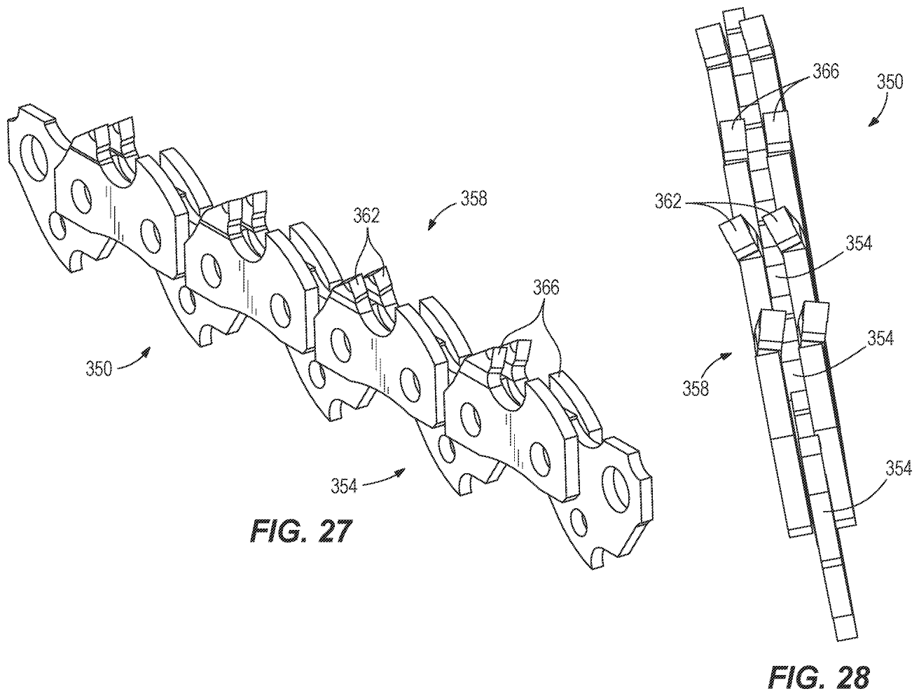

In reference to FIGS. 27 and 28, a chainsaw chain 350 includes a plurality of drive links 354 and a plurality of cutters 358 similar to the cutters 10 of FIG. 2. The plurality of cutters 358 includes a first set of cutters 362 that are set in the left direction and a second set of cutters 366 that are set in the right direction. Each set of cutters 362, 366 is formed of a pair of cutters that are parallel to each other. As such, cutting teeth of the first set of cutters 362 are longitudinally aligned and cutting teeth of the second set of cutters 366 are longitudinally aligned. At least one drive link of the plurality of drive links 354 is disposed between the pair of cutters to maintain the chainsaw chain 350 along the guide bar 6 of the chainsaw 1. In other embodiments, the chainsaw chain 350 includes a third set of cutters having a pair of cutters, in which one of the pair of cutters is set in the left direction as the other of the pair of cutters is set in the right direction.

To form the cutting arrangement of the chainsaw chain 350, the first set of cutters 362 alternates with the second set of cutters 366 along the chainsaw chain 350. In another embodiment of the chainsaw chain 350, the cutting pattern can alternate between a plurality of the first set of cutters 362 and a plurality of the second set of cutters 366. In other embodiments of the chainsaw chain 350, the cutting pattern also includes the third set of cutters, such that the cutting pattern alternates between the first set of cutters 362, the second set of cutters 366, and the third set of cutters.

In another embodiment of the chainsaw chain 350, the plurality of cutters 358 can be made of a fourth set of cutters that are not set in either the right direction or the left direction. Rather, each cutting tooth of the fourth set of cutters extends upward and parallel to the vertical axis of the cutter. In other embodiments of the chainsaw chain 350, the cutting pattern alternates between the third set of cutters and the fourth set of cutters. In some embodiments of the chainsaw chain 350, the cutting pattern alternates between the first set of cutters 362, the second set of cutters 366, and the fourth set of cutters.

In each embodiment of the chainsaw chain 350, the cutting pattern of the chainsaw chain 350 does not include a plurality of tie straps 18. In such an embodiment, the plurality of tie straps 18 is configured to interconnect consecutive drive links 14 together to provide spacing between consecutive cutters 358. Without tie straps 18, the cutting pattern of the chainsaw chain 350 consists of different sets of cutters adjacent each other without a substantial gap defined therebetween by the tie strap 22 and the drive link 16. Therefore, assembling the chainsaw chain 350 without the tie straps 18 will increase the number of components configured to perform cutting operations.

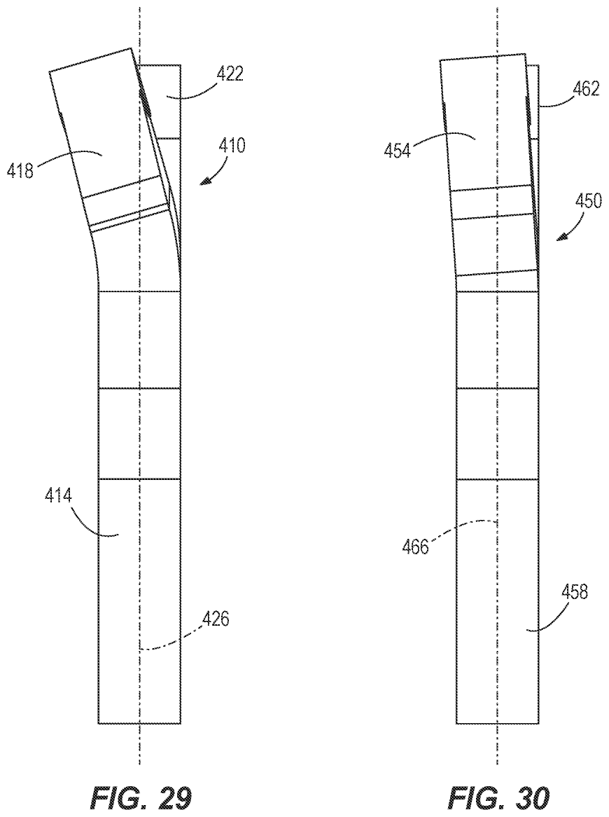

FIGS. 29-32 illustrate multiple embodiments of other cutters. The cutters are similar to the cutter 12 discussed herein above with reference to FIGS. 3 and 6, and the following description focuses primarily on the differences between the cutter 12 and the cutters.

In reference to FIG. 29, a cutter 410 includes a cutter body 414, a cutting tooth 418, and a feed limiter 422 integrally formed with the cutter body 414 and opposite the cutting tooth 418. The cutter 410 defines a vertical axis 426 extending perpendicular to the cutter body 414. In relation to the vertical axis 426, the cutting tooth 418 is oriented at an oblique angle defined by a first magnitude. In the illustrated embodiment, the oblique angle is, for example, about 15 degrees. The cutting tooth 418 is also set in a left direction relative to the cutter body 414.

FIG. 30 illustrates another embodiment of a cutter 450, in which the cutter 450 includes a cutting tooth 454, a cutter body 458, and a feed limiter 462. A vertical axis 466 is defined along the cutter 450, such that the vertical axis 466 is oriented perpendicular to the cutter body 458. The cutting tooth 454 is set in a left direction relative to the cutter body 458, as the cutting tooth 454 is positioned at an oblique angle relative to the cutter body 458 at a second magnitude. In the illustrated embodiment, the oblique angle is, for example, about 5 degrees such that the second magnitude is less than the first magnitude of the cutter 410 (FIG. 29).

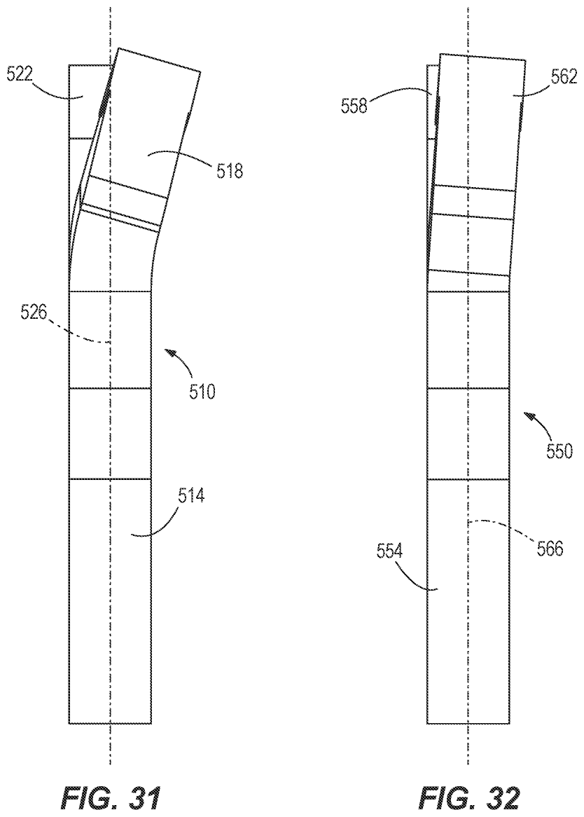

In reference to FIG. 31, another embodiment of a cutter 510 is illustrated. The cutter 510 includes a cutter body 514, a cutting tooth 518 integrally formed with the cutter body 514, and a feed limiter 522 integrally formed on the cutter body 514 and opposite the cutting tooth 518. The cutting tooth 518 is positioned at an oblique angle relative to a vertical axis 526 defined perpendicular to the cutter body 514, in which the oblique angle is defined as the first magnitude. In the illustrated embodiment, the oblique angle is, for example about 15 degrees. Additionally, the cutting tooth 518 is set to extend in a right direction.

In reference to FIG. 32, another embodiment of a cutter 550 is illustrated. The cutter 550 includes a cutter body 554, a feed limiter 558, and a cutting tooth 562. A vertical axis 566 is defined by the cutter 550, such that the vertical axis 566 is perpendicular to the cutter body 554. The cutting tooth 562 extends in a right direction and is oriented at an oblique angle relative to the vertical axis 566 at a second magnitude. In the illustrated embodiment, the oblique angle is, for example about 5 degrees such that the second magnitude is less than the first magnitude of the cutter 510 (FIG. 31).

In another embodiment of a cutter, the cutter includes a cutter body, a feed limiter integrally formed with the body cutter, and a cutting tooth opposite the feed limiter. The cutting tooth also extends parallel to the feed limiter and a vertical axis of the cutter. As such, the cutting tooth is unset relative to the feed limiter.

In the embodiments of FIGS. 29-32, the cutting teeth 418, 518 of respective cutters 410, 510 are structured such that the cutting tooth 418, 518 is taller than the feed limiter 422, 522 by a first amount. In comparison to the cutters 450, 550 having respective cutting teeth 454, 562 that are taller than the respective feed limiters 462, 558 by a second amount that is less than the first amount. The differences in height may be affected by the set magnitude of the cutting teeth 418, 454, 518, 562. In some embodiments, the cutting teeth 418, 454, 518, 562 may have other heights relative to each other, regardless of set magnitude. For example, some of the cutting teeth 418, 454, 518, 562 may be relatively short, while other cutting teeth 418, 454, 518, 562 may be relatively tall. Cutters with different height cutting teeth may be arranged in various patterns along the length of a chainsaw chain.

The chainsaw chain 7 can also include a cutting pattern with a first set of cutters and a second set of cutters, in which each set of cutters is defined by a pair of cutters parallel to each other. The first set of cutters is made of cutters similar to either the cutter 410 of FIG. 29 or the cutter 510 of FIG. 31. Specifically, the cutting teeth of the respective cutters 410, 510 are taller than the feed limiters 422, 522. The second set of cutters is made of cutters similar to either the cutter 450 of FIG. 30 or the cutter 550 of FIG. 32. In this case, the cutting teeth 454, 562 of the cutters 459, 559 are less tall than the feed limiters 462, 558.

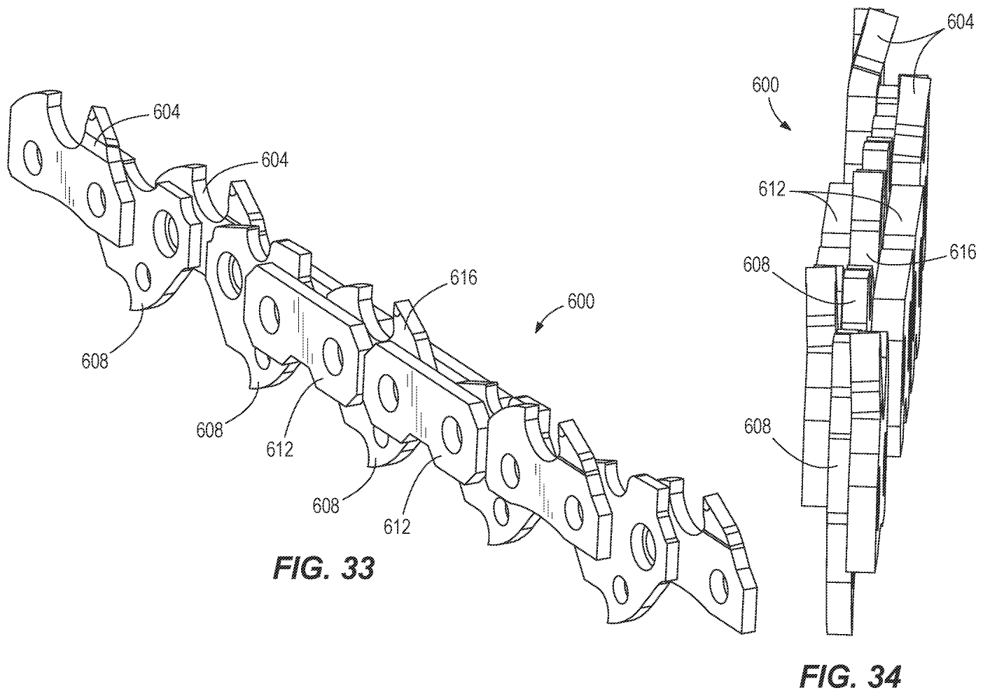

In reference to FIGS. 33 and 34, another embodiment of a chainsaw chain 600 is illustrated. The chainsaw chain 600 includes a plurality of cutters 604, a plurality of drive links 608, a plurality of tie straps 612 configured to interconnect consecutive drive links of the plurality of drive links 608, and a plurality of center cutters 616. The plurality of cutters 604 include a first set of cutters with cutting teeth oriented in a right direction and a second set of cutters with cutting teeth oriented in a left direction. In other embodiments of the chainsaw chain 600, the chain 600 can include a third set of cutters having cutters with cutting teeth that are unset and extend upright, rather than extend in the left direction or the right direction. The plurality of tie straps 612 are defined as a pair of ties straps parallel with each other, such that a gap is defined therebetween. The plurality of center cutters 616 are positioned within the gap defined by the pair of tie straps 612.

At least one of the center cutters 616 includes a body, one or more rivet holes extending through the body, a tang integrally formed along a bottom portion of the body, and a cutting tooth integrally formed along a top portion of the body. The cutting tooth includes a cutting tip secured to the cutting tooth by various welding methods and ground to a desired shape. For example, the shape of the cutting tip is similar to a cutting tip formed on the cutting teeth of the plurality of cutters 604. The cutting tip may also be formed of carbide. The plurality of center cutters 616 further includes a feed limiter opposite the cutting tooth, and a gullet defined between the cutting tooth and the feed limiter. Having the tang and the cutting tip integrally formed to the body of each center cutter allows the plurality of center cutters 616 to simultaneously serve as a cutter and a drive link. Therefore, the plurality of center cutters 616 is configured to perform cutting operations, as well as maintain a chainsaw chain along a guide bar of a chainsaw.

With the plurality of cutters 604 and the plurality centers cutters 616, the chainsaw chain 600 is structured to have more components configured to make cutting operations. In this case, either the plurality of cutters 604 or the plurality of center cutters 616 can be used for scoring operations or cutting operations. This arrangement of the chainsaw chain 600 will also provide a variable pitch by adjusting the position of the cutters 604 with respect to the position of the rivets 20 along the chainsaw chain 600.

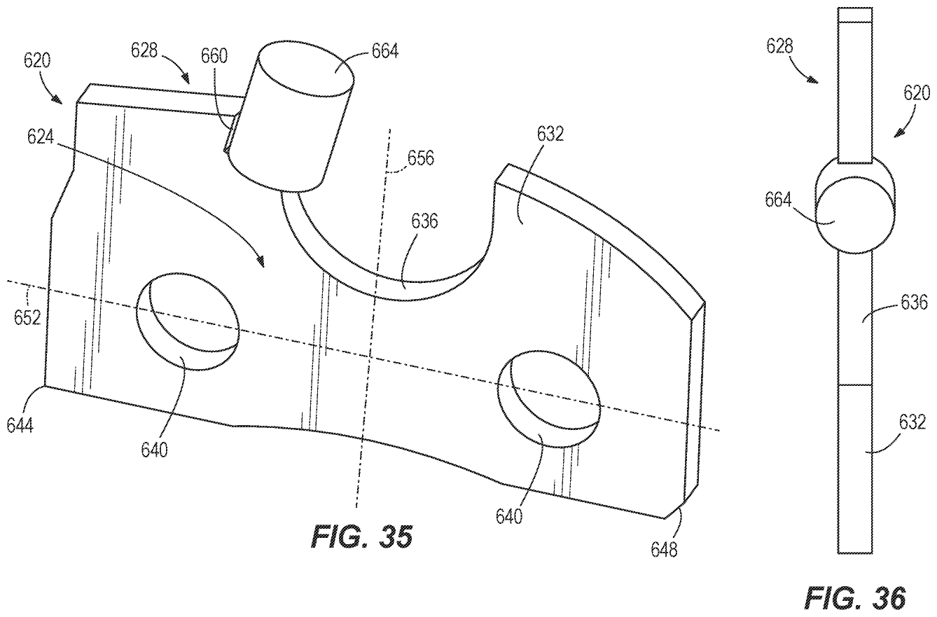

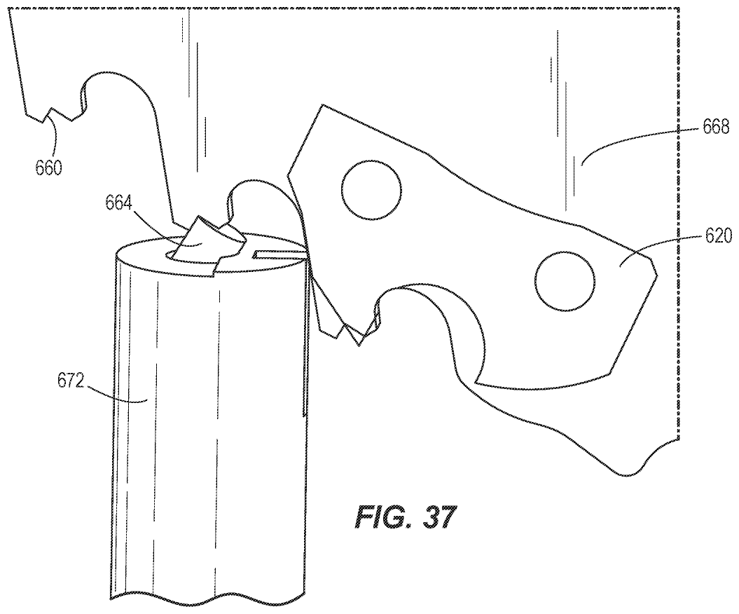

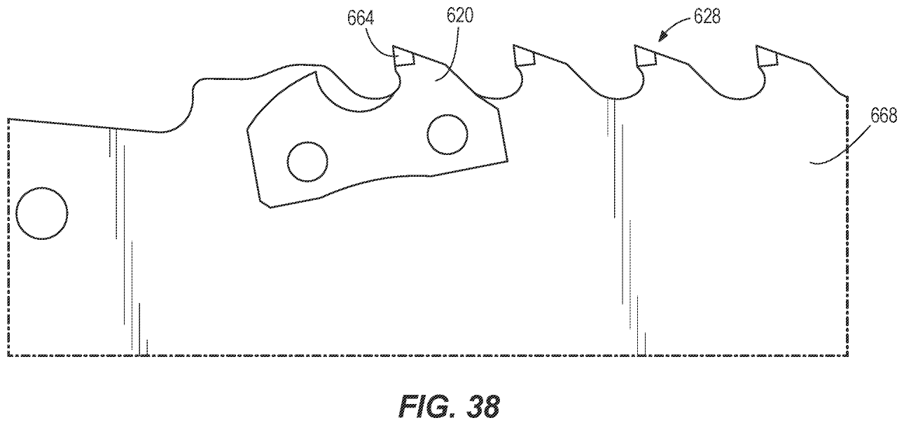

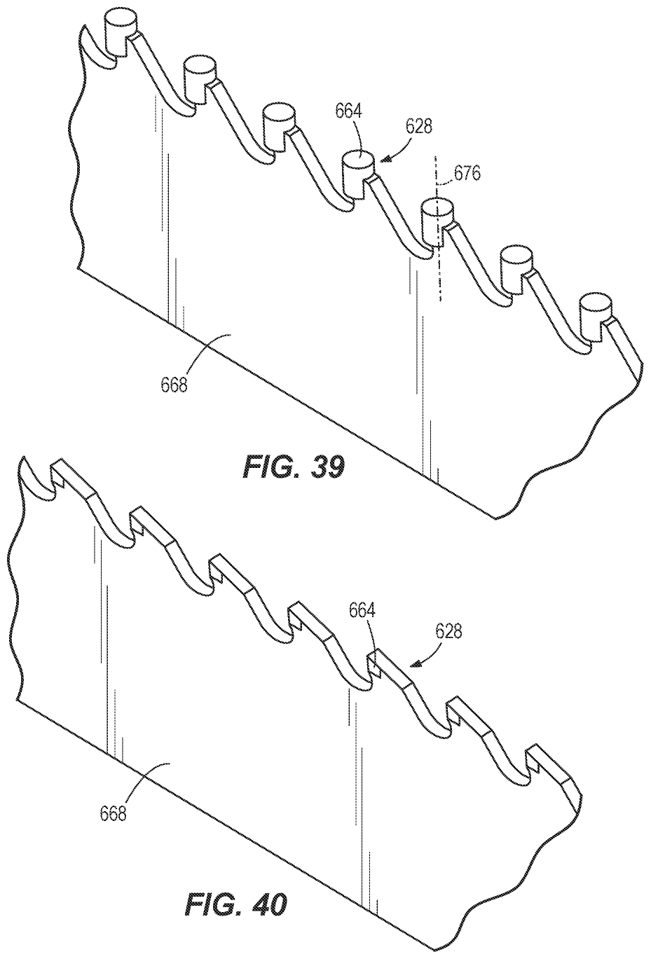

In reference to FIGS. 35-40, another embodiment of a cutter 620 is illustrated. The cutter 620 includes a cutter body 624, a cutting tooth 628, a feed limiter 632, a gullet 636, one or more rivet holes 640 extending through the cutter body 624, a heel 644, and a toe 648. The cutter body 624 defines a longitudinal axis 652 extending through the rivet holes 640 of the cutter 620 and a vertical axis 656 oriented perpendicular to the longitudinal axis 652. The cutting tooth 628 and the feed limiter 632 are formed along a top portion of the cutter body 624 as the feed limiter 632 is disposed between the cutting tooth 628 and the feed limiter 632. The heel 644 and the toe 648 are formed along a bottom portion of the cutter body 624. The cutting tooth 628 of the cutter 620 includes a pocket 660 and a cutting insert 664 securely coupled to the pocket 660 by resistance welding. In the illustrated embodiment, the cutting insert 664 is a piece carbide having a cylindrical shape. The cutting insert 664 is not limited to a cylindrical shape, rather the cutting insert 664 can be rectangular, spherical, etc. The cutting insert 664 is also not limited to carbide and can be formed by other materials.

A blade backer 668, formed of steel (e.g., high speed steel), is provided with a shape of the pocket 660 of the cutter 620 formed along an edge of the blade backer 668. The cutting insert 664 is secured to the pocket 660 by resistance welding while the cutting insert 664 is held within an electrode base 672 during the welding process. As the cutting insert 664 is welded to the pocket 660, the cutting insert 664 is positioned in an axial orientation such that an axial axis 676 of the cutting insert 664 is parallel to the vertical axis 656 of the cutter 620. Welding the cutting insert 664 to the pocket 660 in the axial orientation increases the strength of the weld formed between the cutting insert 664 and the cutter 620.

After the cutting insert 664 has been welded to the pocket 660, the blade backer 668 and the cutting insert 664 is then ground to form the cutting tooth 628. The cutting tooth 628 has a shape similar to the cutting tooth 334 of the cutter 312 illustrated in FIG. 21. In some embodiments, the cutting tooth 628 can be set in either in a right direction or a left direction. In other embodiments, the cutting tooth 628 is unset or extends upright. Once the cutting tooth 628 is set, the remaining structure of the cutter 620 is removed from the blade backer 668. For example, the cutting tooth 628 may be cut out of the blade backer 668 by laser cutting.

Although the invention has been described in detail with reference to certain preferred embodiments, variations and modifications exist within the scope and spirit of one or more independent aspects of the invention as described.

What is claimed is:

1. A chainsaw chain for a chainsaw, the chainsaw chain comprising:
a plurality of drive links configured to connect the chainsaw chain to the chainsaw, each drive link including a drive link body, a rivet hole extending through the drive link body, and a tang extending from the drive link body and configured to engage a drive element of the chainsaw;
a plurality of cutters configured to cut a workpiece during a cutting operation, each cutter including
a cutter body having a rivet hole extending therethrough,
a cutting tooth coupled to an upper portion of the cutter body,
a carbide cutting tip coupled to the cutting tooth,
a feed limiter coupled to the upper portion of the cutter body and spaced from the cutting tooth, and
a gullet defined between the cutting tooth and the feed limiter; and
a plurality of rivets received within corresponding rivet holes of the plurality of drive links and the plurality of cutters to couple the plurality of drive links and the plurality of cutters together.

2. The chainsaw chain of claim 1, further comprising a plurality of tie straps, wherein each tie strap includes a tie strap body and a rivet hole extending through the tie strap body, and wherein the plurality of rivets is also received within corresponding rivet holes of the plurality of tie straps to couple the plurality of drive links, the plurality of cutters, and the plurality of tie straps together.

3. The chainsaw chain of claim 1, wherein the cutter body of each cutter has a toe and a heel formed on a bottom portion of the cutter body and spaced from each other, and wherein the toe and the heel are formed as chamfer-like edges.

4. The chainsaw chain of claim 1, wherein the rivet hole of each cutter body is a first rivet hole, and wherein the cutter body of each cutter has a second rivet hole extending therethrough and a longitudinal axis extending through the first rivet hole and the second rivet hole.

5. The chainsaw chain of claim 4, wherein a major dimension of the carbide cutting tip of at least one cutter is oriented at an oblique angle relative to the longitudinal axis.

6. The chainsaw chain of claim 4, wherein a major dimension of the carbide cutting tip of at least one cutter is oriented perpendicular to the longitudinal axis.

7. The chainsaw chain of claim 4, wherein a major dimension of the carbide cutting tip of at least one cutter is oriented parallel to the longitudinal axis.

8. The chainsaw chain of claim 1, wherein the cutting tooth of at least one cutter is set relative to the feed limiter.

9. The chainsaw chain of claim 1, wherein the carbide cutting tip of at least one cutter has a width that is greater than a width of a corresponding cutter body.

10. The chainsaw chain of claim 1, wherein each cutter also includes a top plate that extends outward and perpendicular to the cutter body.

11. The chainsaw chain of claim 10, wherein a cutting insert of at least one cutter extends across an entire lead edge of the top plate.

12. The chainsaw chain of claim 10, wherein a cutting insert of at least one cutter extends across a portion of a lead edge of the top plate.

13. The chainsaw chain of claim 1, wherein a portion of a cutting insert of at least one cutter overlays a portion of a corresponding gullet.

14. A method of manufacturing a chainsaw chain for a chainsaw, the method comprising:
providing a plurality of drive links, each drive link including a drive link body, a rivet hole extending through the drive link body, and a tang extending from the drive link body and configured to engage a drive element of the chainsaw;
providing a plurality of cutters, each cutter including a cutter body having a rivet hole extending therethrough;
forming a cutting tooth on each cutter, the cutting tooth made of a first material;
welding a cutting tip to the cutting tooth of each cutter, the cutting tip made of a second material that is different than the first material; and
inserting a rivet into the rivet hole of each drive link and the rivet hole of each cutter to couple the plurality of drive links and the plurality of cutters together.

15. The method of claim 14, further comprising
providing a plurality of tie straps, each tie strap including a tie strap body and a rivet hole extending therethrough; and
inserting a rivet into the rivet hole of each tie strap to couple the plurality of drive links, the plurality of cutters, and the plurality of tie straps together.

16. The method of claim 14, wherein welding the cutting tip to the cutting tooth includes welding the cutting tip to the cutting tooth of each cutter by resistance welding.

17. The method of claim 14, wherein welding the cutting tip to the cutting tooth includes welding the cutting tip to the cutting tooth of each cutter by laser welding.

18. The method of claim 14, wherein welding the cutting tip to the cutting tooth includes welding the cutting tip to the cutting tooth of each cutter by cladding.

19. The method of claim 14, wherein the first material is steel, and wherein the second material is carbide.

20. The method of claim 14, further comprising grinding the cutting tip of each cutter to a desired shape.

21. A method of manufacturing a chainsaw chain for a chainsaw, the method comprising:
providing a plurality of drive links, each drive link including a drive link body, a rivet hole extending through the drive link body, and a tang extending from the drive link body and configured to engage a drive element of the chainsaw;
providing a plurality of cutters, each cutter including a cutter body having a pair of rivet holes extending therethrough and a longitudinal axis extending through the pair of rivet holes, a cutting tooth coupled to an upper portion of the cutter body, a feed limiter coupled to the upper portion of the cutter body and spaced from the cutting tooth, and a gullet defined between the cutting tooth and the feed limiter;
coupling a cutting insert to the cutting tooth of each cutter;
grinding the cutting insert to a desired shape; and
inserting a rivet into the rivet hole of each drive link and the rivet hole of each cutter to couple the plurality of drive links and the plurality of cutters together.

22. The method of claim 21, further comprising
providing a plurality of tie straps, each tie strap including a tie strap body and a rivet hole extending therethrough; and
inserting a rivet into the rivet hole of each tie strap to couple the plurality of drive links, the plurality of cutters, and the plurality of tie straps together.

23. The method of claim 21, wherein coupling the cutting insert to the cutting tooth includes coupling a cylindrical carbide piece to the cutting tooth of each cutter.

24. The method of claim 23, wherein coupling the cylindrical carbide piece to the cutting tooth includes orienting the cylindrical carbide piece of at least one cutter at an oblique angle relative to the longitudinal axis.

25. The method of claim 23, wherein coupling the cylindrical carbide piece to the cutting tooth includes orienting the cylindrical carbide piece of at least one cutter parallel to the longitudinal axis.

26. The method of claim 23, wherein coupling the cylindrical carbide piece to the cutting tooth includes orienting the cylindrical carbide piece of at least one cutter perpendicular to the longitudinal axis.

27. The method of claim 23, wherein each cutter defines a vertical axis that is perpendicular to the longitudinal axis, and wherein coupling the cylindrical carbide piece to the cutting tooth includes orienting the cylindrical carbide piece of at least one cutter in a vertical direction that is parallel to the vertical axis.

28. The method of claim 21, wherein the cutting tooth of each cutter includes a pocket, and wherein coupling the cutting insert to the cutting tooth includes inserting a portion of the cutting insert into the pocket.
